(19) United States
(12) Patent Application Publication
(10) Pub. No.: US 2025/0066552 A1
(43) Pub. Date: Feb. 27, 2025

(54) RESIN COMPOSITION

(71) Applicant: Nan Ya Plastics Corporation, Taipei (TW)

(72) Inventors: Te-Chao Liao, Taipei (TW); Chi-Lin Chen, Taipei (TW); Hung-Yi Chang, Taipei (TW)

(73) Assignee: Nan Ya Plastics Corporation, Taipei (TW)

(21) Appl. No.: 18/467,735

(22) Filed: Sep. 15, 2023

(30) Foreign Application Priority Data
Aug. 23, 2023 (TW) 112131604

(51) Int. Cl. C08G 73/12; C08K 3/36; C08L 63/00

(52) U.S. Cl. CPC C08G 73/12; C08K 3/36; C08L 63/00; C08L 2203/20; C08L 2205/03

(57) ABSTRACT

The disclosure provides a resin composition, which includes 30 wt % to 50 wt % of a bismaleimide resin; 1 wt % to 10 wt % of an epoxy resin; 1 wt % to 10 wt % of a benzoxazine resin; 1 wt % to 5 wt % of a hardener; 10 wt % to 40 wt % of a filler; and 0.1 wt % to 3 wt % of a coupling agent, based on a total weight of the resin composition.

### CROSS-REFERENCE TO RELATED APPLICATION

This application claims the priority benefit of Taiwan application serial no. 112131604, filed on Aug. 23, 2023. The entirety of the above-mentioned patent application is hereby incorporated by reference herein and made a part of this specification.

### BACKGROUND

### Technical Field

The disclosure relates to a composition, and particularly relates to a resin composition.

### Description of Related Art

In recent years, due to the development of 5G communication and millimeter wave communication, mobile phones, base stations, servers, etc. have been applied to higher frequencies (6˜77 GHz), so higher frequency substrate materials have to be used to be suitable for 5G high frequencies. The conventional epoxy resin has a dielectric constant from 3.5 to 5.0, a dissipation factor greater than 0.01 and the dissipation factor is high, which is not enough for the rapidly developing high-frequency communication applications. In addition, the direct application of amine hardener and phenolic resin hardener to copper foil substrates cannot overcome the disadvantage of high transmission loss. Therefore, there is still a need to develop materials that have excellent electrical properties and meet the characteristic requirements of high-frequency printed circuit boards, such as materials having a high glass transition temperature, a low dielectric constant, and a low dissipation factor.

### SUMMARY

The disclosure provides a resin composition, including: based on the total weight of the resin composition, 30 wt % to 50 wt % of a bismaleimide resin; 1 wt % to 10 wt % of an epoxy resin; 1 wt % to 10 wt % of a benzoxazine resin; 1 wt % to 5 wt % of a hardener; 10 wt % to 40 wt % of a filler; and 0.1 wt % to 3 wt % of a coupling agent.

In an embodiment of the disclosure, the bismaleimide resin includes DCPD-BMI, KI-50P, KI-70, MIR-3000, MIR-5000, or a combination thereof.

In an embodiment of the disclosure, the weight percentage of the epoxy resin is 1 wt % to 3 wt %.

In an embodiment of the disclosure, the resin composition further includes 0.1 wt % to 3 wt % of a catalyst.

In an embodiment of the disclosure, the resin composition further includes 5 wt % to 15 wt % of a flame resisting agent.

The disclosure provides an electronic component, including a substrate formed by the resin composition.

In an embodiment of the disclosure, the substrate has a dielectric constant less than or equal to 3.5 at a frequency of approximately 10 GHz.

In an embodiment of the disclosure, the substrate has a dissipation factor less than or equal to 0.003 at a frequency of approximately 10 GHz.

In an embodiment of the disclosure, the glass transition temperature of the substrate is greater than or equal to 260° C.

In an embodiment of the disclosure, the substrate is a copper foil substrate.

Based on the above, the resin composition of the disclosure has the characteristic of not forming polar groups during reaction, so it is not easily polarized in an electric field, thereby significantly reducing the dielectric constant. In addition, when applied to copper foil substrates, the resin composition of the disclosure can achieve a high glass transition temperature (greater than or equal to 260° C.), a low dielectric constant (less than or equal to 3.5), and a low dissipation factor (less than or equal to 0.003).

### DESCRIPTION OF THE EMBODIMENTS

The following are examples of the contents of the disclosure described in detail. The implementation details provided in the embodiments are for illustration purposes, and are not intended to limit the scope of protection of the disclosure. Persons with ordinary knowledge in the art can modify or change these implementation details according to the needs of the actual implementation.

Ranges may be expressed herein as “approximately” one particular value to “approximately” another particular value, which can also be expressed directly as one particular value and/or to another particular value. When expressing the range, another embodiment includes the one particular value and/or to the other particular value. Similarly, when values are expressed as approximations, by use of the antecedent “approximately”, it is understood that the particular value forms another embodiment. It is further understood that an endpoint of each range is clearly related or unrelated to the other endpoint.

In this document, non-limiting terms (such as: may, can, for example, or other similar terms) are non-essential or optional implementation, inclusion, addition, or presence.

Unless otherwise defined, all terms (including technical and scientific terms) used herein have the same meaning as commonly understood by one of ordinary skill in the art to which this disclosure belongs. It will also be understood that the terms (such as those defined in commonly used dictionaries) should be interpreted to have meanings consistent with those in the relevant technical context and should not be interpreted in an idealized or overly formal sense, unless explicitly defined as such.

As used herein, the so-called “bivalent organic group” is an organic group having two bonding positions, and the “bivalent organic group” can form two chemical bonds via these two bonding positions.

The disclosure provides a resin composition, including: based on the total weight of the resin composition, 30 wt % to 50 wt % of a bismaleimide (BMI) resin; 1 wt % to 10 wt % of an epoxy resin; 1 wt % to 10 wt % of a benzoxazine resin; 1 wt % to 5 wt % of a hardener; 10 wt % to 40 wt % of a filler; and 0.1 wt % to 3 wt % of a coupling agent. The disclosure combines the bismaleimide resin with the epoxy resin, the benzoxazine resin, the hardener, the filler, and the coupling agent, which can improve the heat resistance of high-frequency substrate materials and reduce the dielectric constant and the dissipation factor of high-frequency substrate materials.

In some embodiments, based on the total weight of the resin composition, the weight percentage of the bismaleimide resin is 30 wt % to 50 wt %, such as 35 wt %, 40 wt %, or 45 wt %.

In some embodiments, the bismaleimide resin has a structure represented by the following Formula (1):

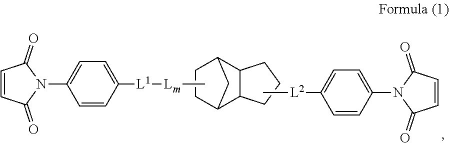

in which L represents a dicyclopentadienyl group, a divalent organic group derived from a phenolic compound, or a combination thereof, L¹ and L² each represent a divalent organic group derived from a phenolic compound, and m represents an integer from 0 to 18.

In some embodiments, the phenolic compounds include phenol. In some embodiments, the divalent organic group is preferably a divalent organic group including a maleimide group. In some embodiments, L is preferably a combination of a dicyclopentadienyl and a divalent organic group derived from a phenolic compound. In some embodiments, L represents

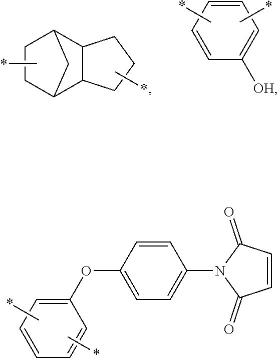

or a combination thereof, in which * represents a bonding position. In some embodiments, L¹ and L² each represent

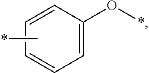

in which * represents the bonding position.

In some embodiments, the bismaleimide resin has a structure represented by the following Formula (2):

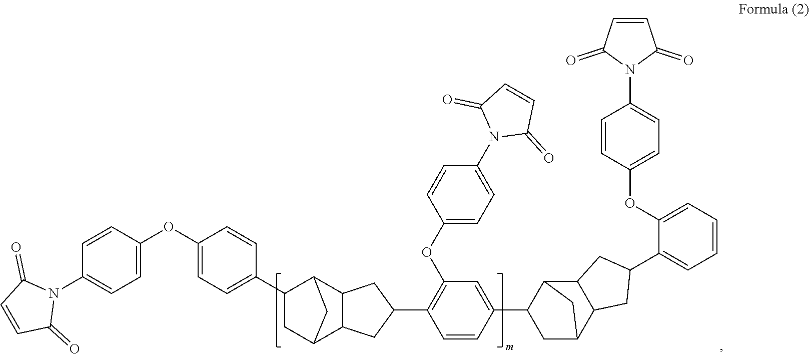

in which m represents an integer from 0 to 18, preferably from 2 to 10.

For example, a synthesis method of bismaleimide resin includes the following. First, 1 mol of dicyclopentadiene phenolic resin (trade name ERM6140, manufactured by Songyuan Co., Ltd., weight average molecular weight 1,300) and 1.25 mol of 4-halonitrobenzene (in which the halogen may be fluorine, chlorine, bromine, or iodine) is added into 6 moles of dimethylacetamide (DMAC) used as a reaction solvent and is reacted at a temperature of 120° C. for 300 minutes, so as to carry out the nitration reaction. Next, hydrogen gas is introduced to react at a temperature of 90° C. for 480 minutes to perform a hydrogenation reaction, so as to form a modified dicyclopentadiene-type diamine. Next, 3 moles of maleic anhydride and 9.7 wt % of toluenesulfonic acid are added to react at a temperature of 120° C. for 420 minutes to produce a second resin, which is a bismaleimide resin whose main chain includes a dicyclopentadiene structure (DCPD-BMI for short) and has a structure represented by Formula (2), and an average molecular weight may be of 800 to 10,000, preferably 1,000 to 4,000.

In some embodiments, based on the total weight of the resin composition, the weight percentage of the epoxy resin is 1 wt % to 10 wt %, such as 2 wt %, 4 wt %, or 6 wt %. In some embodiments, the epoxy resin is an epoxy resin with the trade name of 437 provided by NANYA Plastics Industry Co., Ltd.

In some embodiments, based on the total weight of the resin composition, the weight percentage of the benzoxazine resin is 1 wt % to 10 wt %, such as 2 wt %, 4 wt %, or 6 wt %. In some embodiments, the benzoxazine resin is a benzoxazine resin with the trade name of 234 provided by NANYA Plastics Industry Co., Ltd.

In some embodiments, based on the total weight of the resin composition, the weight percentage of the hardener is 1 wt % to 5 wt %, such as 2 wt %, 3 wt %, or 4 wt %. In some embodiments, the hardener is a hardener with the trade name of HPC-8000 provided by DIC (Dainippon Ink & Chemicals, Inc.)

In some embodiments, based on the total weight of the resin composition, the weight percentage of the filler is 10 wt % to 40 wt %, such as 20 wt %, 25 wt %, or 30 wt %. In some embodiments, the filler has a spherical shape, and the particle size (D50) of the filler is 0.3 μm to 3 μm. In some embodiments, the filler has a maximum particle size (D99) no greater than 10 μm. In some embodiments, the filler contains a surface modification such as acrylic or vinyl. In some embodiments, the filler is the SiO₂ filler provided by Sibelco Company.

In some embodiments, based on the total weight of the resin composition, the weight percentage of the coupling agent is 0.1 wt % to 3 wt %, such as 0.5 wt %, 1 wt %, or 1.5 wt %. Adding the coupling agent can enhance the compatibility and crosslinking degree of the resin composition to the glass fiber cloth and powder. In some embodiments, the content of the coupling agent in the resin composition is 0.1 part per hundred parts of resin (phr) to 5 phr of the coupling agent. In some embodiments, the content of the coupling agent in the resin composition is 0.5 phr to 1 phr. In some embodiments, the coupling agent is a siloxane coupling agent. In some embodiments, the coupling agent is vinyl silane or acrylic silane. In some embodiments, the coupling agent is a coupling agent with the trade name of Z-6030 provided by DOW.

In some embodiments, the resin composition further includes a flame resisting agent. In some embodiments, based on the total weight of the resin composition, the weight percentage of the flame resisting agent is 5 wt % to 15 wt %, such as 8 wt %, 10 wt %, or 12 wt %. In some embodiments, the flame resisting agent is a phosphorus-based flame resisting agent. In some embodiments, the flame resisting agent is a flame resisting agent with the trade name of PX200 provided by Daihachi Chemical Industry Co., Ltd.

In some embodiments, the resin composition further includes a catalyst. In some embodiments, based on the total weight of the resin composition, the weight percentage of the catalyst is 0.1 wt % to 3 wt %, such as 0.5 wt %, 1 wt %, or 1.5 wt %. In some embodiments, the content of the catalyst in the resin composition is preferably 0.5 phr to 1.2 phr. In some embodiments, the catalyst is a catalyst with the trade name of DCP provided by ARKEMA.

The resin composition of the disclosure may be suitable for forming a substrate of an electronic component. In some embodiments, the substrate is a copper foil substrate. In some embodiments, the substrate has the following specifications: a dielectric constant (Dk) less than or equal to approximately 3.5; a dissipation factor (Df) less than or equal to approximately 0.003; a glass transition temperature (Tg) greater than 260° C. (for example, approximately 260° C. to 270° C.); a peel strength greater than or equal to approximately 5 lb/in (e.g., approximately 5 lb/in to 6.5 lb/in); and/or a heat resistance which has passed a test.

The implementation and effect of the disclosure will be described in detail below by using the copper foil substrates made of the resin compositions of the embodiments and comparative examples. However, the disclosure is not limited to the following embodiments and comparative examples.

According to composition ratios in Table 1 below, the resin composition is mixed with MEK to form a varnish of a thermosetting resin composition. The resulting varnish is impregnated with Nanya fiberglass cloth (NANYA Plastics Industry Co., Ltd., cloth model 1078LD) at room temperature, and then dried at approximately 130° C. (the temperature of the impregnator) for a few minutes to obtain a prepreg with a resin content of 60 wt %. Afterward, 4 pieces of prepreg are stacked between two pieces of copper foil with a thickness of approximately 35 μm, kept at a constant temperature at a pressure of 25 kg/cm² and a temperature of 85° C. for 20 minutes, heated to 210° C. at a heating rate of 3° C./min, kept at a constant temperature for 120 minutes, and then slowly cooled to 130° C. to produce a 0.5 mm thick copper foil substrate.

In Embodiment 1 to Embodiment 6, the “DCPD-BMI” used is a bismaleimide resin (DCPD-MI) having the structure represented by the Formula (2).

In Embodiment 2 to Embodiment 4, the “KI-50P” and “KI-70” used are respectively bismaleimide resins of trade names KI-50P and KI-70 series sold by K.I Chemical Industry Co., Ltd.

In Embodiment 1, Embodiment 5, Embodiment 6, Comparative Example 2, Comparative Example 3, and Comparative Example 6, the “MIR-3000” and “MIR-5000” used are respectively bismaleimide resins of trade names MIR-3000 and MIR-5000 series sold by Nippon Kayaku Co., Ltd.

In Comparative Example 1 to Comparative Example 6, the “BMI-1000” and “BMI-2300” used are respectively bismaleimide resins of trade names BMI-1000 and BMI-2300 series sold by Daiwa Fine Chemicals (Taiwan) Co., Ltd.

In Embodiment 1 to Embodiment 6 and Comparative Example 1 to Comparative Example 6, the “HPC-8000” used is a hardener with the trade name HPC-8000 sold by DIC (Dainippon Ink & Chemicals, Inc.)

In Embodiment 1 to Embodiment 6 and Comparative Example 1 to Comparative Example 6, the “DCP” used is a catalyst with the trade name DCP series sold by ARKEMA.

In Embodiment 1 to Embodiment 6 and Comparative Example 1 to Comparative Example 6, the “Z-6030” used is a siloxane coupling agent with the trade name Z-6030 series sold by DOW.

In Embodiment 1 to Embodiment 6, the “437” used is an epoxy resin with the trade name 437 series sold by NANYA Plastics Industry Co., Ltd.

In Comparative Example 1 to Comparative Example 3, the “NC-3000-H” used is an epoxy resin with the trade name of NC-3000-H series sold by Nippon Kayaku Corporation.

In Comparative Example 4 to Comparative Example 6, the “HP-9500” used is an epoxy resin with the trade name of HP-9500 series sold by DIC (Dainippon Ink & Chemicals, Inc.)

In Embodiment 1 to Embodiment 6, Comparative Example 1, Comparative Example 2, Comparative Example 4, and Comparative Example 6, the “234” used is a benzoxazine resin with the trade name of 234 series sold by NANYA Plastics Industry Co., Ltd.

In Comparative Example 3 and Comparative Example 5, the “BA-BXZ” used is a benzoxazine resin with the trade name BA-BXZ series sold by Konishi Chemical Company.

In Embodiment 1 to Embodiment 6 and Comparative Example 1 to Comparative Example 6, the “PX200” used is a flame resisting agent with the trade name PX200 series sold by Daihachi Chemical Industry Co., Ltd.

In Embodiment 1 to Embodiment 6 and Comparative Example 1 to Comparative Example 6, the SiO₂ used is a SiO₂ filler sold by Sibelco Company.

Items of the copper foil substrate such as the glass transition temperature, the dielectric constant, the dissipation factor, the peel strength, and the heat resistance are evaluated in the following manner, and the evaluation results are listed in Table 1.

### Glass Transition Temperature (Tg)

The glass transition temperature (Tg) of the resin composition in the copper foil substrate is measured by using a dynamic mechanical analyzer (DMA). When the Tg is high, it shows that the resin composition has a good ability to resist phase change, that is, a good heat resistance.

### Dielectric Constant (Dk)

The dielectric constant at a frequency of approximately 10 GHz is measured by using a dielectric analyzer (model E4991A, manufactured by Agilent Technologies, Inc.) When the dielectric constant is small, it shows that the resin composition in the copper foil substrate has good dielectric properties.

### Dissipation Factor (Df)

The dissipation factor at a frequency of approximately 10 GHz is measured by using a dielectric analyzer (model E4991A, manufactured by Agilent Technologies, Inc.) When the dissipation factor is small, it shows that the resin composition in the copper foil substrate has good dielectric properties.

### Peel Strength

The peel strength between the prepreg and the copper foil is tested according to IPC-TM-650-2.4.8 test method.

### Heat Resistance

Heat the copper foil substrate sample in a stress pot with a temperature of 120° C. and a stress of 2 atm for 120 minutes and then immerse in a soldering furnace of 288° C., and record the time required for the board to blister. If the board blistering time exceeds 10 minutes, it is indicated as “OK”, and if the board blistering time is shorter than 10 minutes, it is indicated as “NG”.

TABLE 1

| | | Embodiment | | | | | | Comparative example | | | | | |
|---|---|---|---|---|---|---|---|---|---|---|---|---|---|
| Ingredient / Evaluation items | | 1 | 2 | 3 | 4 | 5 | 6 | 1 | 2 | 3 | 4 | 5 | 6 |
| Bismaleimide | DCPD-BMI | 25 | 15 | 5 | 10 | 25 | 25 | 15 | | | | 25 | |
| resin | KI-50P | | 20 | 20 | 15 | | | | | | | | |
| (wt %) | KI-70 | | | 25 | 20 | | | | | | | | |
| | MIR-3000 | 20 | | | | | 20 | | 15 | | | | 30 |
| | MIR-5000 | | | | | 20 | | | | 15 | | | |
| | BMI-1000 | | | | | | | 10 | 10 | 10 | 35 | | |
| | BMI-2300 | | | | | | | | | | 20 | 30 | 30 |
| Hardener | HPC-8000 | 2 | 2.5 | 3 | 2 | 3 | 4 | 2 | 2 | 2 | 3 | 2 | 1 |
| (wt %) | | | | | | | | | | | | | |
| Catalyst | DCP | 1 | 1 | 1 | 1 | 0.8 | 0.7 | 0.5 | 1 | 0.8 | 1 | 1 | 1 |
| (phr) | | | | | | | | | | | | | |
| Siloxane | Z-6030 | 1 | 1 | 1 | 1 | 1 | 1 | 1 | 1 | 1 | 1 | 1 | 1 |
| coupling agent | | | | | | | | | | | | | |
| (phr) | | | | | | | | | | | | | |
| Epoxy resin | 437 | 3 | 3 | 2 | 2 | 1 | 2 | | | | | | |
| (wt %) | NC-3000-H | | | | | | | 13 | 22 | 1 | | | |
| | HP-9500 | | | | | | | | | | 3 | 3 | 2 |
| Benzoxazine | 234 | 6 | 5 | 5 | 4 | 2 | 1 | 16 | 5 | | 2 | | 2 |
| resin | BA-BXZ | | | | | | | | | 25 | | 3 | |
| (wt %) | | | | | | | | | | | | | |
| Flame | PX200 | 14 | 14 | 14 | 14 | 14 | 14 | 14 | 14 | 14 | 14 | 9 | 14 |
| resisting agent | | | | | | | | | | | | | |
| (wt %) | | | | | | | | | | | | | |
| Filler | SiO₂ | 28 | 28 | 28 | 28 | 28 | 28 | 28 | 28 | 28 | 18 | 23 | 13 |
| (wt %) | | | | | | | | | | | | | |

| | | | | | | | | | | | | |
|---|---|---|---|---|---|---|---|---|---|---|---|---|
| Tg | 260 | 270 | 265 | 265 | 260 | 260 | 220 | 210 | 225 | 270 | 270 | 265 |
| Dk (10 GHz) | 3.3 | 3.2 | 3.2 | 3.25 | 3.1 | 3.15 | 3.8 | 4.2 | 3.7 | 3.5 | 3.7 | 3.6 |
| Df × 10³ (10 GHz) | 2.5 | 2.4 | 2.4 | 2.5 | 2.4 | 2.5 | 4.5 | 5.2 | 4.1 | 7.0 | 6.5 | 7.2 |
| Peel strength (lb/in) | 5 | 5.6 | 5 | 5 | 6 | 6.5 | 3 | 2.7 | 3.7 | 4.1 | 2.5 | 2.9 |
| Heat resistance | OK | OK | OK | OK | OK | OK | OK | OK | NG | OK | NG | OK |

### <Evaluation Results>

From Embodiment 1 to Embodiment 6 of [Table 1], it may be seen that, from the copper foil substrates prepared by the resin composition having the composition ratios of the disclosure, the measured Tg is not lower than 260° C., the dielectric constant Dk is less than 3.5, and the dissipation factor Df is less than 0.003. Moreover, the copper foil substrates of Embodiment 1 to Embodiment 6 also exhibit good peel strength (≥5 lb/in) and good heat resistance.

However, from Comparative Example 1 to Comparative Example 6 of [Table 1], it may be seen that, when the weight percentage of the bismaleimide resin is less than 30 wt % or greater than 50 wt %, the weight percentage of the epoxy resin is greater than 10 wt %, and the benzoxazine resin is greater than 10 wt %, the measured Tg is lower than 260° C., the dielectric constant Dk is greater than 3.5, and the dissipation factor Df is greater than 0.003.

In summary, the resin composition of the disclosure has the characteristic of not forming polar groups during reaction, so it is not easily polarized in an electric field, thereby significantly reducing the dielectric constant. In addition, the resin composition of the disclosure can be directly or indirectly applied to copper foil substrates, and can be further processed to become other livelihood, industrial, or suitable electronic components or electronic products (such as: circuit boards or copper foil substrates). In addition, when applied to copper foil substrates, the resin composition of the disclosure is beneficial to the improvement of the glass transition temperature, the improvement of the peel strength, the improvement of the heat resistance, and/or the reduction of the dissipation factor.

What is claimed is:

1. A resin composition, comprising:
based on a total weight of the resin composition,
30 wt % to 50 wt % of a bismaleimide resin;
1 wt % to 10 wt % of an epoxy resin;
1 wt % to 10 wt % of a benzoxazine resin;
1 wt % to 5 wt % of a hardener;
10 wt % to 40 wt % of a filler; and
0.1 wt % to 3 wt % of a coupling agent.

2. The resin composition as claimed in claim 1, wherein the bismaleimide resin comprises DCPD-BMI, KI-50P, KI-70, MIR-3000, MIR-5000, or a combination thereof.

3. The resin composition as claimed in claim 1, wherein the weight percentage of the epoxy resin is 1 wt % to 3 wt %.

4. The resin composition as claimed in claim 1, further comprising 0.1 wt % to 3 wt % of a catalyst.

5. The resin composition as claimed in claim 4, further comprising 5 wt % to 15 wt % of a flame resisting agent.

6. An electronic component, comprising:
a substrate formed by the resin composition according to claim 1.

7. The electronic component as claimed in claim 6, wherein the substrate has a dielectric constant less than or equal to 3.5 at a frequency of approximately 10 GHz.

8. The electronic component as claimed in claim 6, wherein the substrate has a dissipation factor less than or equal to 0.003 at a frequency of approximately 10 GHz.

9. The electronic component as claimed in claim 6, wherein a glass transition temperature of the substrate is greater than or equal to 260° C.

10. The electronic component as claimed in claim 6, wherein the substrate is a copper foil substrate.
